(19) United States
(12) Patent Application Publication
(10) Pub. No.: US 2006/0258302 A1
(43) Pub. Date: Nov. 16, 2006

(54) Electronic devices

(75) Inventors: Rong-Fong Ding, Pingtung County (TW); Teng-Yi Tsai, Taipei County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/430,597

(22) Filed: May 8, 2006

(30) Foreign Application Priority Data
May 10, 2005 (TW) TW94115019

(51) Int. Cl. H04B 1/38; H04M 1/00

(52) U.S. Cl. 455/90.3; 455/575.1

(57) ABSTRACT

Electronic devices are provided. An electronic device includes a main body, a first casing, a second casing, a first rod, a second rod and a slider movable along a rail of the main body. The first casing includes a first hinge, and the second casing includes a second hinge. The first rod pivotally connects the slider and the first hinge, and the second rod pivotally connects the slider and the second hinge. When the slider moves between a first position and a second position of the rail, the first and second casings move in opposite directions with respect to the main body.

### BACKGROUND

The invention relates in general to electronic devices and in particular to electronic devices with symmetrical movable mechanisms.

Referring to FIG. 1, a conventional collapsible electronic device, such as a mobile phone or PDA, comprises a main body M and a cover C pivotally connected via a hinge H, rotatable as the arrow indicates. As shown in FIGS. 2A and 2B, other types of electronic devices with sliding mechanisms are also widely applied in mobile phones or PDAs.

### SUMMARY

Electronic devices are provided. An electronic device includes a main body, a first casing, a second casing, a first rod, a second rod and a slider movable along a rail of the main body. The first casing includes a first hinge, and the second casing includes a second hinge. The first rod pivotally connects the slider and the first hinge, and the second rod pivotally connects the slider and the second hinge. When the slider moves between a first position and a second position of the rail, the first and second casings move in opposite directions with respect to the main body.

### DESCRIPTION OF THE DRAWINGS

FIG. 1 is a perspective diagram of a conventional collapsible electronic device;

FIGS. 2A and 2B are perspective diagrams of conventional electronic devices with movable mechanisms.

FIG. 3A is a perspective diagram of an embodiment of an electronic device when closed;

FIGS. 3B and 3C show an embodiment of an electronic device when opened;

FIGS. 4A and 4B show an embodiment of an electronic device with the first and second casings enclosing the main body;

FIG. 4C is a perspective diagram of an embodiment of a slider;

FIGS. 5A and 5B show an embodiment of an electronic device with the first and second casings opened with respect to the main body;

FIG. 6A is perspective diagram of a slider with magnets disposed at both ends;

FIG. 6B is perspective diagram of a third magnet attracted by the first and second magnets according to FIG. 6A;

FIG. 7A is a perspective diagram of the rail, the first and second rods with magnets disposed thereon;

FIG. 7B is a perspective diagram of a fifth magnet repelled by the fourth magnet according to FIG. 7A;

FIG. 8A is a perspective diagram of the first and second printed circuit boards disposed on the first and second casings respectively; and

FIG. 8B is a perspective diagram of the second printed circuit board connected to the main printed circuit board via a flexible printed circuit board.

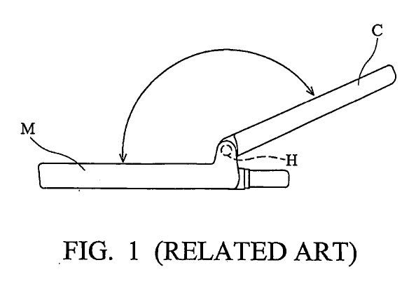

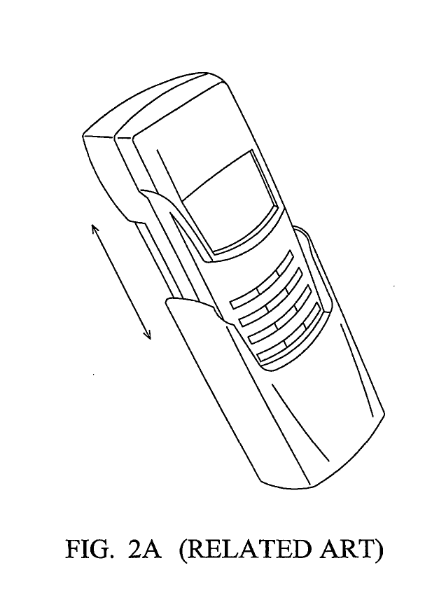

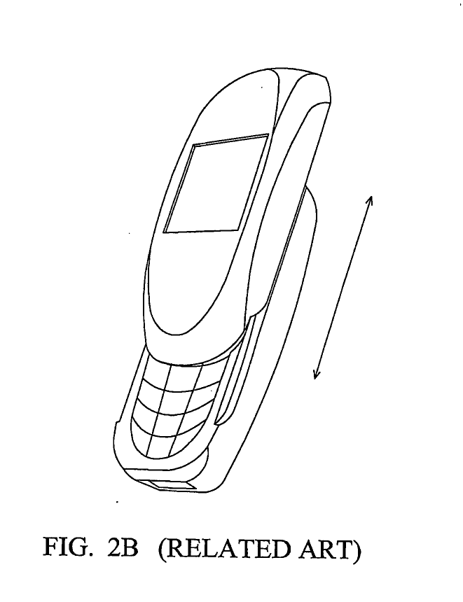

### DETAILED DESCRIPTION

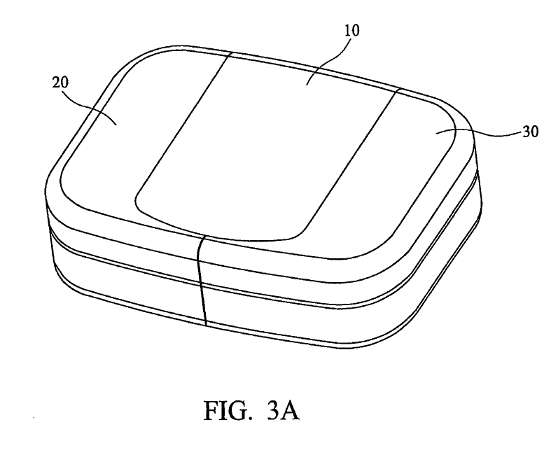

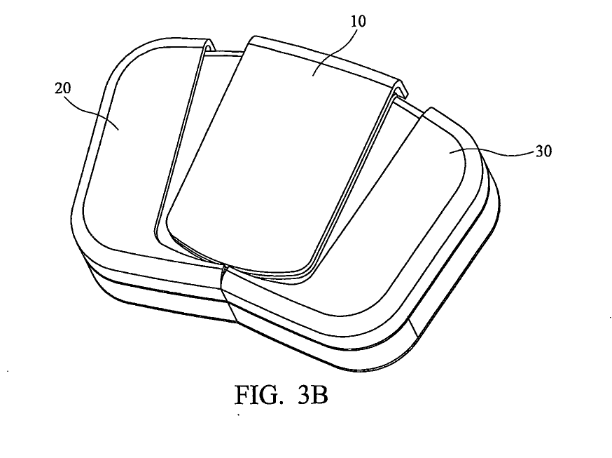

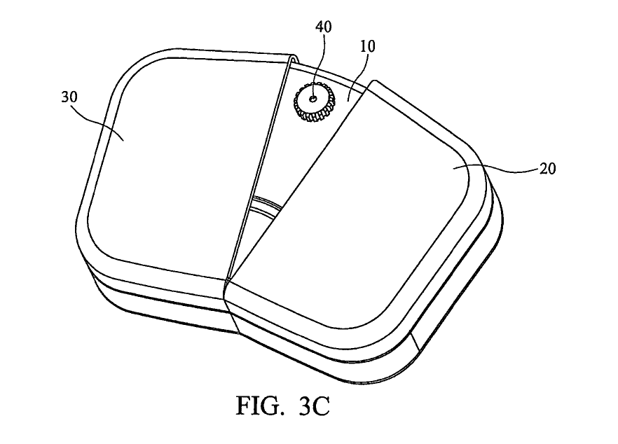

Referring to FIGS. 3A-3C, an embodiment of an electronic device, such as a mobile phone or PDA, primarily comprises a main body 10, a first casing 20 and a second casing 30. The first and second casings 20 and 30 are symmetrically movable with respect to the main body 10. When the electronic device is opened, as shown in FIGS. 3B and 3C, a lens 40 at the center of the main body 10 is exposed to capture a digital image.

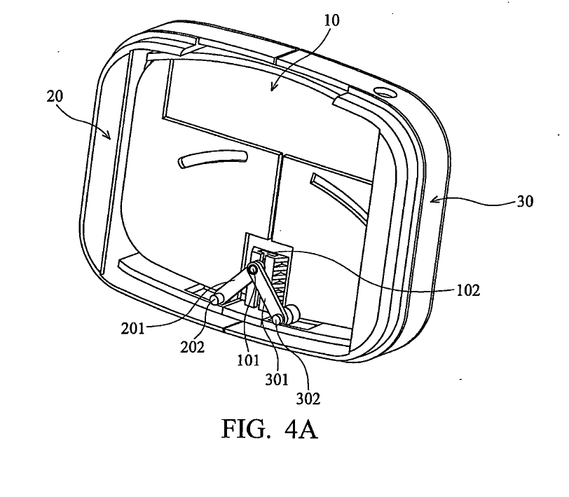

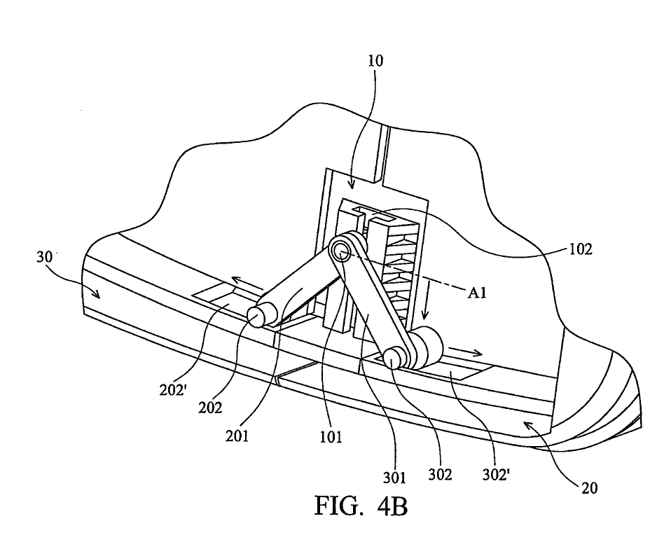

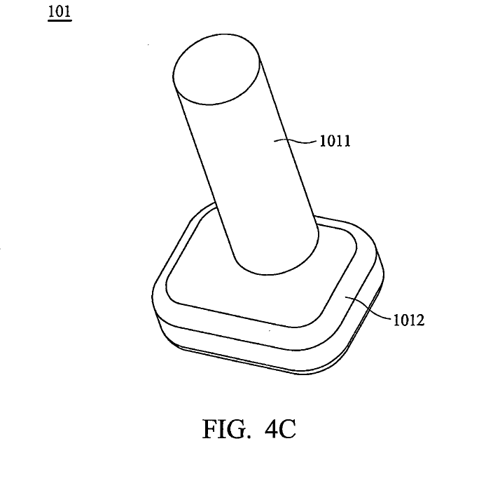

Referring to FIGS. 4A and 4B, when the electronic device is closed, the first and second casings 20 and 30 abut each other and enclose the main body 10. The electronic device comprises a first rod 201, a second rod 301 and a slider 101 pivotally connecting the first and second rods 201 and 301. As shown in FIG. 4C, the slider 101 has a sliding portion 1012 and a pivot portion 1011 projecting therefrom. The first and second rods 201 and 301 are hinged via the pivot portion 1011. Specifically, the slider 101 is movable disposed in a linear rail 102 of the main body 10.

With respect to FIG. 4B, an end of the first rod 201 pivotally connects to a first hinge 202 on the first casing 20, and correspondingly, an end of the second rod 301 pivotally connects to a second hinge 302 on the second casing 30. When the slider 101 linearly moves downward along the rail 102 from a first position A1, as shown in FIG. 4B, the first and second rods 201 and 301 symmetrically slide the first and second hinges 202 and 302 outward along a first slot 202′ and a second slot 302′ of the main body 10, respectively.

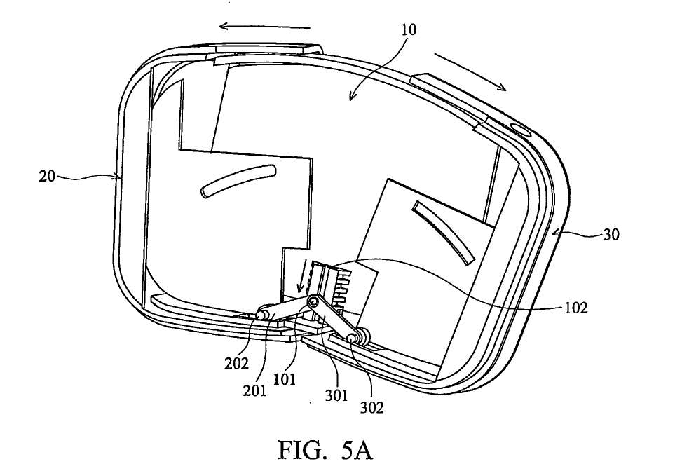

Referring to FIGS. 5A and 5B, as the slider 101 linearly moves downward from the first position A1 to a second position A2 along the rail 102, the first and second hinges 202 and 302 slide outward along the first and second slots 202′ and 302′, such that the first and second casings 20 and 30 symmetrically separate and open in opposite directions. In this embodiment, the user can manually open the electronic device by merely pulling the first casing 20 or the second casing 30 outward.

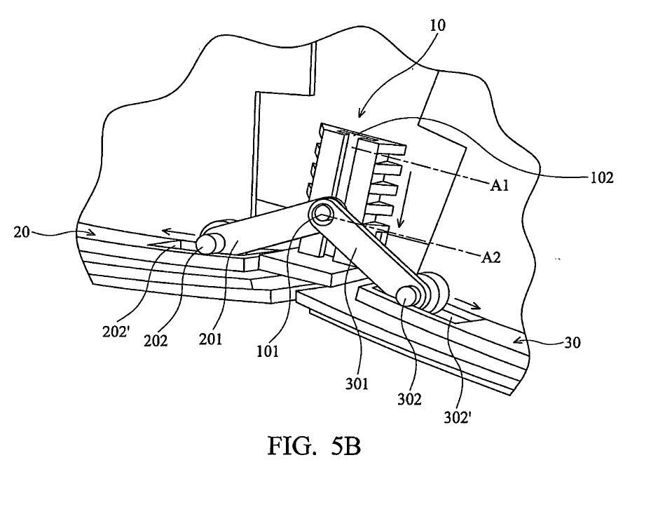

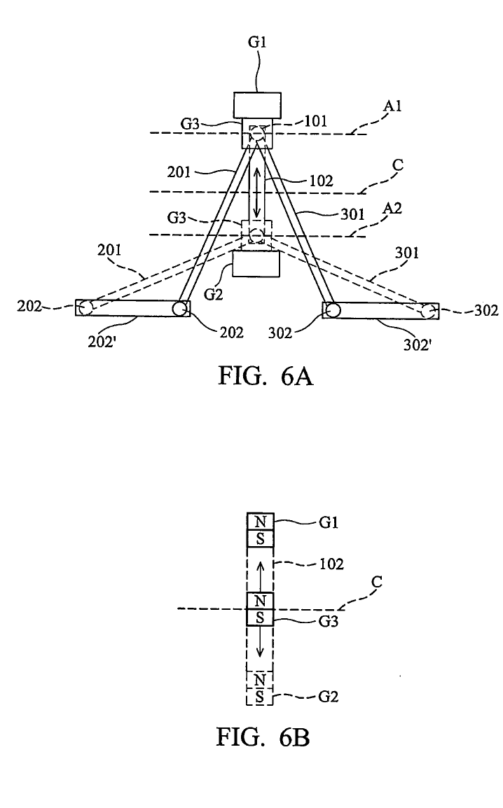

In some embodiments, magnetic components are provided to facilitate operation of the symmetrical mechanisms while opening or closing the electronic device. Referring to FIGS. 6A and 6B, an embodiment of the electronic device comprises a first magnet G1, a second magnet G2 and a third magnet G3 arranged in substantially the same magnetic field direction. The first and second magnets G1 and G2 are disposed on both ends of the rail 102, close to the first and second positions A1 and A2 respectively, and the third magnet G3 is disposed on the slider 101. As shown in FIG. 6B, the third magnet G3 moves between the first and second magnets G1 and G2 by magnetic attraction. When the third magnet G3 is closer to the first magnet G1 than the second magnet G2, the third magnet G3 moves to the first position A1 by magnetic attraction from the first magnet G1. Alternatively, when the third magnet G3 is closer to the second magnet G2 than the first magnet G1, the third magnet G3 moves to the second position A2 by magnetic attraction from the second magnet G2.

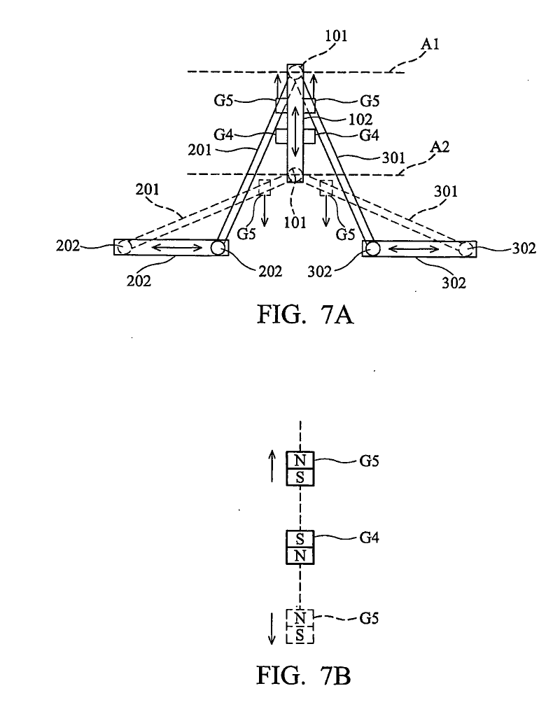

Referring to FIGS. 7A and 7B, an embodiment of the electronic device comprises a fourth magnet G4 disposed in the middle of the rail 102 and a pair of fifth magnets G5 disposed on the first and second rods 201 and 301, respectively. When the fifth magnets G5 move above the fourth magnet G4, the fourth magnet G4 repels the fifth magnets G5 upward, driving the slider 101 to the first position A1. Alternatively, as the fifth magnets G5 moves below the fourth magnet G4, the fourth magnet G4 repels the fifth magnets G5 downward, driving the slider 101 to the second position A2. As shown in FIG. 7B, magnetic field directions of the fourth magnet G4 and the fifth magnets G5 are substantially opposite

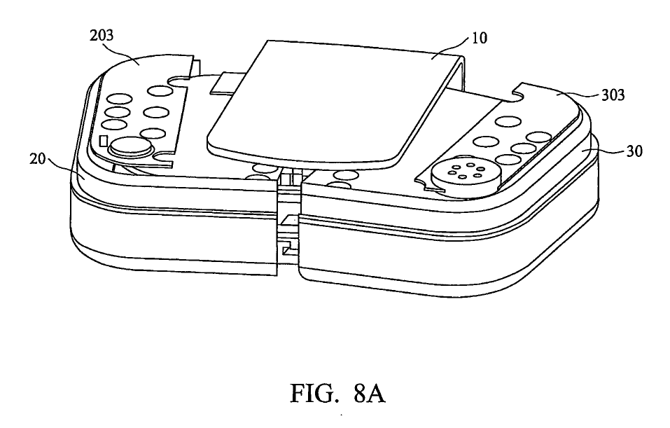

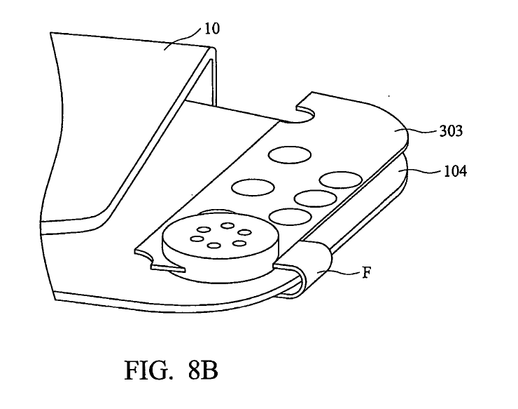

Referring to FIGS. 8A and 8B, an embodiment of the electronic device further comprises a first printed circuit board 203 disposed on the first casing 20, a second printed circuit board 303 disposed on the second casing 30, and a main printed circuit board 104 fixed to the main body 10. As shown in FIG. 8B, specifically, the second printed circuit board 303 is connected to the main printed circuit board 104 via a flexible printed circuit board F. Similarly, the first printed circuit board 203 and the main printed circuit board 104 can also be connected via a flexible printed circuit board. As the first and second casings 20 and 30 move with respect to the main body 10, the first and second printed circuit boards 203 and 303 can remain in electrical connection with the main printed circuit board 104 via the flexible printed circuit board F.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An electronic device, comprising:
a main body, comprising a rail;
a first casing, comprising a first hinge;
a second casing, comprising a second hinge;
a slider, movable along the rail;
a first rod, pivotally connecting the first casing and the slider; and
a second rod, pivotally connecting the second casing and the slider, wherein when the slider moves between a first position and a second position along the rail, the first and second casings are impelled in opposite directions with respect to the main body via the first and second rods.

2. The electronic device as claimed in claim 1, wherein the first and second casings symmetrically move in opposite directions with respect to the main body as the slider slides along the rail.

3. The electronic device as claimed in claim 1, wherein the main body further comprises a first slot with the first hinge sliding therein, and a second slot with the second hinge sliding therein when the slider slides along the rail.

4. The electronic device as claimed in claim 1, wherein the slider linearly moves along the rail.

5. The electronic device as claimed in claim 1, wherein the first and second casings abut each other and enclose the main body when the slider is in the first position.

6. The electronic device as claimed in claim 1, further comprising a first magnet, a second magnet and a third magnet, wherein the first and second magnets are disposed on the main body close to the first and second positions respectively, and the third magnet is disposed on the slider, attracted by the first magnet and the second magnet, so that the slider alternatively moves to the first position or the second position.

7. The electronic device as claimed in claim 6, wherein magnetic field directions of the first, second and third magnets are substantially the same.

8. The electronic device as claimed in claim 6, wherein the first and second magnets are disposed at both ends of the rail.

9. The electronic device as claimed in claim 1, further comprising a fourth magnet disposed between the first and second positions, and a fifth magnet disposed on the first rod, wherein the fourth magnet applies a repulsion on the fifth magnet, impelling the slider to the first position or the second position.

10. The electronic device as claimed in claim 9, wherein magnetic field directions of the fourth and the fifth magnets are substantially opposite.

11. An electronic device, comprising:
a first casing, comprising a first hinge;
a first printed circuit board, connected to the first casing;
a second casing, comprising a second hinge;
a main body, comprising a rail;
a slider, sliding along the rail;
a main printed circuit board, connected to the main body;
a flexible printed circuit board, connecting the main printed circuit board and the first printed circuit board;
a first rod, pivotally connecting the first hinge and the slider; and
a second rod, pivotally connecting the second hinge and the slider, wherein when the slider moves between a first position and a second positions along the rail, the first and second casings are impelled in opposite directions with respect to the main body via the first and second rods.

12. The electronic device as claimed in claim 11, wherein the first and second casings symmetrically move in opposite directions with respect to the main body as the slider slides along the rail.

13. The electronic device as claimed in claim 11, wherein the main body further comprises a first slot with the first hinge sliding therein, and a second slot with the second hinge sliding therein when the slider slides along the rail.

14. The electronic device as claimed in claim 11, wherein the slider linearly moves along the rail.

15. The electronic device as claimed in claim 11, wherein the first and second casings abut each other and enclose the main body when the slider is in the first position.

16. The electronic device as claimed in claim 11, further comprising a first magnet, a second magnet and a third magnet, wherein the first and second magnets are disposed on the main body close to the first and second positions respectively, and the third magnet is disposed on the slider, attracted by the first magnet and the second magnet, so that the slider alternatively moves to the first position or the second position.

17. The electronic device as claimed in claim 16, wherein magnetic field directions of the first, second and third magnets are substantially the same.

18. The electronic device as claimed in claim 16, wherein the first and second magnets are disposed at both ends of the rail.

19. The electronic device as claimed in claim 11, further comprising a fourth magnet disposed between the first and second positions, and a fifth magnet disposed on the first rod, wherein the fourth magnet applies a repulsion on the fifth magnet, impelling the slider to the first position or the second position.

20. The electronic device as claimed in claim 19, wherein magnetic field directions of the fourth and the fifth magnets are substantially opposite.
